(19) United States
(12) Patent Application Publication
(10) Pub. No.: US 2023/0341755 A1
(43) Pub. Date: Oct. 26, 2023

(54) VEHICLE INTERIOR IMAGE PROJECTION SYSTEM

(71) Applicant: TOYODA GOSEI CO., LTD., Kiyosu-shi (JP)

(72) Inventor: Masato TAKEUCHI, Aichi-ken (JP)

(21) Appl. No.: 18/299,856

(22) Filed: Apr. 13, 2023

(30) Foreign Application Priority Data
Apr. 20, 2022 (JP) 2022-069370

(51) Int. Cl. G03B 21/14

(52) U.S. Cl. CPC G03B 21/145

(57) ABSTRACT

A vehicle interior image projection system includes: a projector configured to project an image onto a projection target, the projector is provided so that an optical axis of the projector is inclined with respect to a surface of the projection target, and a projection region of the image projected onto the projection target by the projector has an elliptical shape.

### CROSS-REFERENCE TO RELATED APPLICATION

This application is based on and claims priority under 35 USC 119 from Japanese Patent Application No. 2022-069370 filed on Apr. 20, 2022.

### TECHNICAL FIELD

The present invention relates to a vehicle interior image projection system.

### BACKGROUND ART

Conventionally, there has been an illumination device including a light guide that guides light emitted from a light source to an irradiated surface in a vehicle interior, and a pattern panel on which a predetermined pattern is formed, in which the pattern is projected onto the irradiated surface by transmitting the light from the light guide through the pattern panel (see JP2014-040194A).

### SUMMARY OF INVENTION

However, according to the illumination device described in JP2014-040194A, since the pattern of the pattern panel is simply projected onto the irradiated surface, there is a disadvantage that expression of a projected image is likely to be monotonous.

An object of the present invention is to provide a vehicle interior image projection system capable of widening a range of expression of an image projected from a projector.

In order to achieve the above object, an aspect of the present invention provides a vehicle interior image projection system according to the following [1] to [5].
[1] vehicle interior mage projection system includes: a projector configured to project an image onto a projection target, the projector is provided so that an optical axis of the projector is inclined with respect to a surface of the projection target, and a projection region of the image projected onto the projection target by the projector has an elliptical shape.
[2] The vehicle interior image projection system according to the above [1], an angle formed by the optical axis of the projector and the surface of the projection target is 5° or more and 80° or less.
[3] The vehicle interior image projection system according to the above [1], an image enlargement ratio of the projector at a projection distance of 400 mm is 50 times or more and 100 times or less.
[4] The vehicle interior image projection system according to any one of the above [1] to [3], the projector is provided inside a door, and the projection target is a door trim attached to the door.
[5] The vehicle interior image projection system according to any one of the above [1] to [3], the projector is Provided in an instrument panel or a console, and the projection target is a floor of a vehicle.

According to the present invention, it is possible to provide the vehicle interior image projection system capable of widening a range of expression of the image projected from the projector.

### BRIEF DESCRIPTION OF DRAWINGS

FIG. 1 is a schematic view of a vehicle interior image projection system according to an embodiment of the present invention.

FIG. 2 is a schematic diagram of a vehicle interior illustrating examples of an installation position of a projector in the vehicle interior image projection system and examples of a position of a projection region corresponding thereto.

FIG. 3A is a side view of a part of a door a case where the projector is installed therein. FIG. 3B a cross-sectional view of the door cut along a line A-A shown in FIG. 3A.

FIGS. 4A and 4B are perspective views of the projector according to the embodiment of the present invention as viewed from different angles.

FIG. 5A is a side view of the projector according to the embodiment of the present invention as viewed from a light extraction side, and FIG. 5B is a cross-sectional view of the projector cut along a cutting line B-B shown in FIG. 5A.

FIG. 6 is an exploded perspective view of the projector according to the embodiment of the present invention.

FIG. 7 is a vertical cross-sectional view of an embodiment of a pattern plate according to the embodiment of the present invention.

### DETAILED DESCRIPTION OF THE INVENTION

### Embodiment

(Configuration of Vehicle Interior Image Projection System)

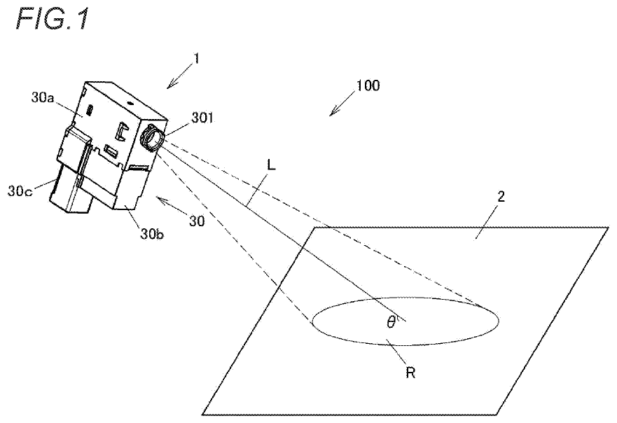

FIG. 1 is a schematic diagram of a vehicle interior image projection system 100 according to an embodiment of the present invention. The vehicle interior image projection system 100 includes a projector 1 that projects an image onto a projection target 2. In the vehicle interior image projection system 100, the projector 1 is installed such that an optical axis L is inclined with respect to a surface of the projection target 2, and a projection region R of the image on the projection target 2 projected by the projector 1 is elliptical.

In the projector 1, light is emitted from a circular projection lens 221 to be described later. Therefore, in a case where the projector 1 is installed such that the optical axis L is orthogonal to the surface of the projection target 2, the projection region R has a substantially perfect circular shape. In the vehicle interior image projection system 100, since the projector 1 is installed such that the optical axis L is inclined with respect to the surface of the projection target 2 as described above, the projection region R has an elliptical shape.

The projection region R is a region including the entire projected image, includes both a bright portion and a dark portion of an image expressed by a pattern of a pattern plate 20 to be described later, that is, both a portion irradiated with light transmitted through a light transmitting portion of the pattern plate 20 and a portion shielded by a light shielding portion of the pattern plate 20 and not irradiated with the light. That is, the projection region R is elliptical regardless of a content of the image expressed by the pattern of the pattern plate 20.

In the vehicle interior image projection system 100, since projector 1 enlarges and projects the pattern of the pattern plate 20 using the projection lens 221, and the projector 1 is installed such that the optical axis L is inclined with respect to the surface of the projection target 2, a path difference between a portion in the projection region R close to the projector 1 and a portion far from the projector 1 increases. Therefore, for example, even if the pattern of the pattern plate 20 is uniform as a whole, a luminance difference between the portion in the projection region R close to the projector 1 and the portion far from the projector 1 becomes large, and graduation expression of brightness is enabled in the projection region R. By utilizing such an effect, according to the vehicle interior image projection system 100, not only is the pattern of the pattern plate 20 simply projected, but also a variety of expressions in a projected image, such as gradation expression in which a pattern gradually disappears or an expression in which a pattern gradually increases, are realized.

In order to increase the path difference of the light in the projection region R and improve visibility of the expression by the luminance difference, an angle θ formed by the optical axis L of the projector 1 and the surface of the projection target 2 is preferably 80° or less, more preferably 50° or less, and still more preferably 20° or less. In order to suppress collapse of the pattern in the projected image, the angle θ is preferably 5° or more.

In order to increase the path difference of the light in the projection region R and improve the visibility of the expression by the luminance difference, it is preferable that an image enlargement ratio of the projector 1 at a projection distance of 400 mm is 50 time or more. Further, in order to suppress protrusion of the projected image from the projection target 2 in an installation mode of the vehicle interior image projection system 100 in a vehicle to be described later, the image enlargement ratio is preferably 100 time or less. Here, the image enlargement ratio at the projection distance of 400 mm of the projector 1 is a magnification of a size of the image projected onto a screen with respect to a size of the pattern of the pattern plate 20 when the screen is placed perpendicularly to the optical axis L at a distance of 400 mm from the projection lens 221.

The projection distance, that is, a distance from a center of the projection lens 221 of the projector 1 to the center of the projection region R is set to a range in which the pattern of the projected pattern plate 20 is not blurred, and is set in a range of, for example, 100 mm or more and 800 mm or less.

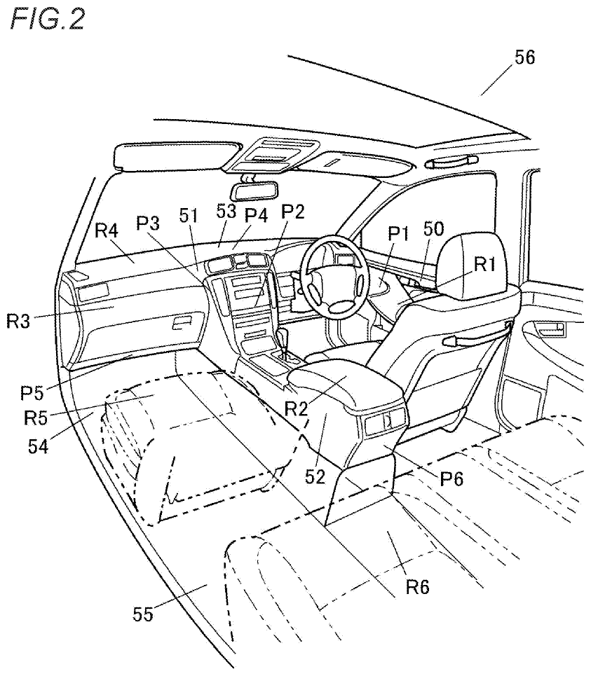

FIG. 2 is a schematic diagram of a vehicle interior illustrating examples P1 to P6 of an installation position of the projector 1 in the vehicle interior image projection system 100 and examples R1 to R6 of a position of the projection region R corresponding thereto.

For example, as indicated by the position P1 in FIG. 2, the projector 1 is installed inside a door 50, for example, inside a pocket of an armrest or inside a convex portion of a front side of the door (in the vicinity of a connection portion with an instrument panel 51 in the case of a door on a driver's seat side or a front passenger seat side). The projection target 2 in this case is, for example, a door trim as indicated by the position R1 in FIG. 2, and the projection region R is provided on a surface of an ornament panel in an upper portion of the door or the like. In FIG. 2, the door 50 indicates the door on the driver's seat side, but may be the door on the front passenger seat side or a door on a rear seat side. In a case where the door 50 is set as an installation target of the projector 1 and the projection target 2 in this way, the angle θ formed by the optical axis L of the projector 1 and the surface of the projection target 2 is preferably 10° or more and 20° or less.

Further, for example, as indicated by the position P2 in FIG. 2, the projector 1 is installed inside a portion located in the vicinity of a center of the instrument panel 51, for example, inside a portion located above the console 52. The projection target 2 in this case is, for example, an upper portion of the console 52 as indicated by the position R2 in FIG. 2, and the projection region R is provided on the surface of a console upper panel or the like.

For example, as indicated by the position P3 in FIG. 2, the projector 1 is installed inside the instrument panel 51, for example, on a back side or a side portion of a face panel of a car navigation system, and on a side portion of an outlet port of an air conditioner. The projection target 2 in this case is, for example, the instrument panel 51 as indicated by the position R3 in FIG. 2, and the projection region R is provided on a surface of an ornament panel in front of a front passenger seat or the like.

Further, for example, as indicated by the position P4 in FIG. 2, the projector 1 is installed inside a bus tab 53 on an upper surface of the instrument panel under the windshield, for example, inside a protruding portion in a periphery of the car navigation system. The projection target 2 in this case is, for example, the bus tab 53 as indicated by the position R4 in FIG. 2, and the projection region R is provided on a surface of a relatively flat portion thereof or the like.

Further, for example, as indicated by the position P5 in FIG. 2, the projector 1 is installed inside a portion located on a lower side of the instrument panel 51, for example, inside a portion in front of the driver's seat or in front of the front passenger seat. The projection target 2 in this case is, for example, a floor 54 under feet of a person on the driver's seat or the front passenger seat as indicated by the position R5 in FIG. 2, and the projection region R is provided on a surface of a floor mat or the like. In a case where the floor 54 under the feet of the person on the driver's seat or the front passenger seat is set as the projection target 2, the angle θ formed by the optical axis L of the projector 1 and the surface of the projection target 2 is preferably 40° or more and 50° or less. In a case where the projector 1 is installed on the lower side of the instrument panel 51, the projection target 2 may be a side surface of the console 52, and the projection region R may be provided on the surface of the console 52. Further, in a case where the floor 54 under the feet of the person on the driver's seat or the front passenger seat is set as the projection target 2, the projector 1 may be installed inside the side surface of the console 52.

Further, for example, as indicated by the position P6 in FIG. 2, the projector 1 is installed inside a rear portion of the console 52, for example, inside a console rear end panel. The projection target 2 in this case is, for example, a floor 55 under feet of a person on a rear seat as indicated by the position R6 in FIG. 2, and the projection region R is provided on an upper surface of a convex portion on a rear side of the console 52, the surface of the floor mat, or the like. In a case where the floor 55 under the foot of the person on the rear seat is set as the projection target 2 in this way, the angle θ formed by the optical axis L of the projector 1 and the surface of the projection target 2 is preferably 40° or more and 50° or less. In a case where the projector 1 is installed inside the rear portion of the console 52, the projection target 2 may be a ceiling 56, and the projection region R may be provided on a surface of the ceiling 56.

In addition, a mode can be implemented in which the projector 1 is installed in a pocket on a lower side of the door and the projection region R is provided on an inner surface of a storage pocket in a lower portion of the door (the door may be any of the door on the driver's seat side, the door on the front passenger seat side, and the door on the rear seat side), a mode in which the projector 1 is installed inside the instrument panel 51 and the projection region R is provided on a surface of an A pillar, a mode in which the projector 1 is installed front of a console box and the projection region R is provided on a surface of a center tray, a mode in which the projector 1 is installed inside the A pillar or a B pillar and the projection region R is provided in a front portion of the ceiling, a mode in which the projector 1 is installed inside the B pillar or a C pillar, and the projection region R is provided in a rear portion of the ceiling, a mode in which the projector 1 is installed inside the B pillar and the projection region R is provided on a surface of an ornament panel in an upper portion of the door on the rear seat side, and the like.

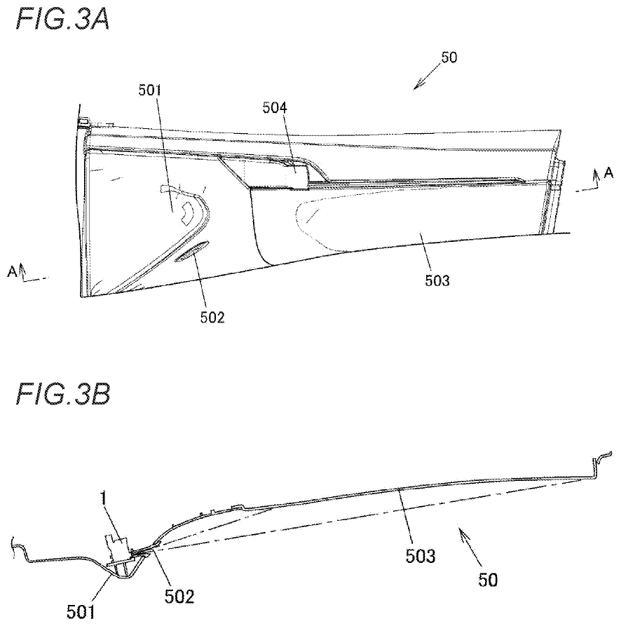

FIG. 3A is a side view of a part of the door 50 in a case where the projector 1 is installed inside the door 50. FIG. 3B is a cross-sectional view of the door 50 taken along a cutting line A-A shown in FIG. 3A.

In the example shown in FIGS. 3A and 3B, the projector 1 is installed inside a convex portion 501 of the ornament panel in the vicinity of the connection portion between the door 50 and the instrument panel 51. The projection region R is provided in a relatively flat region 503 of the ornament panel on a lower side of an inside door handle 504. The light emitted from the projector 1 is emitted onto the region 503 through an opening 502 provided in the convex portion 501. In the example shown in FIGS. 3A and 3B, the angle θ formed by the optical axis L of the projector 1 and a surface of the region 503 which is the projection target 2 is about 10°.

(Configuration of Projector)

Hereinafter, a configuration example of the projector 1 according to the embodiment of the present invention will be described.

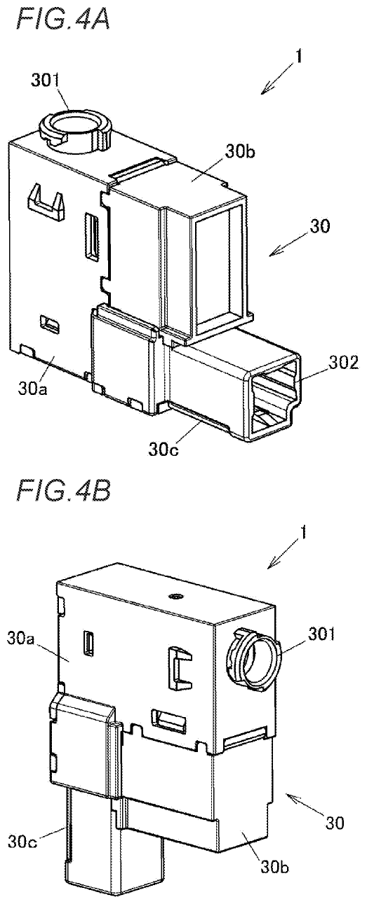

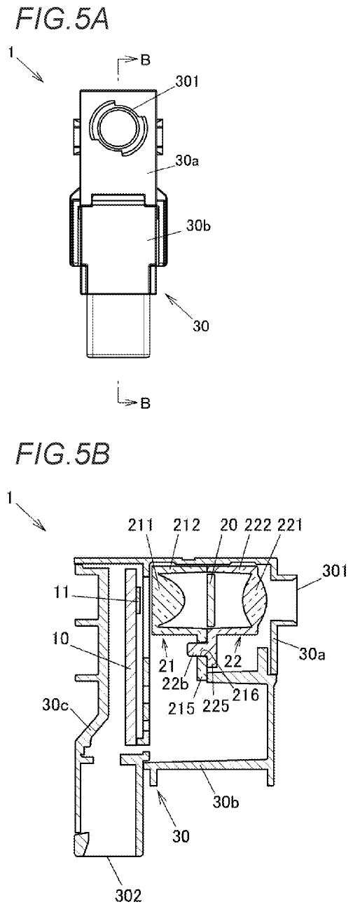

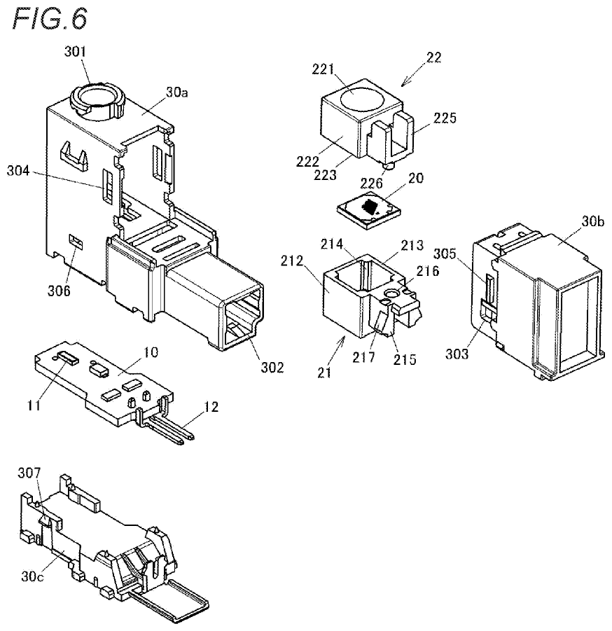

FIGS. 4A and 4B are perspective views of the projector 1 according to the embodiment of the present invention as viewed from different angles. FIG. 5A is a side view of the projector 1 as viewed from a light extraction side, and FIG. 5B is a cross-sectional view of the projector 1 cut along the cutting line B-B shown in FIG. 5A. FIG. 6 is an exploded perspective view of the projector 1.

The projector 1 includes a light source 11 that emits light, the pattern plate 20 having the pattern for projection, a first lens component 21 including a condenser lens 211 that collects light emitted from the light source 11 and transmits the light to the pattern plate 20, and a second lens component 22 including the projection lens 221 for projecting the pattern of the pattern plate 20. In the projector 1, the first lens component 21 and the second lens component 22 sandwich and fix the pattern plate 20 so as to seal the pattern plate 20 inside the first lens component 21 and the second lens component 22.

The light source 11 is a light emitting element including an LED chip, etc. The light source 11 is mounted on a circuit board 10, and a connector 12 for feeding electric power or signals to the light source 11 is connected to the circuit board 10.

The circuit board 10 on which the light source 11 is mounted, the first lens component 21, the second lens component 22, and the pattern plate 20 are accommodated in a housing 30 formed by components 30a, 30b, and 30c. The housing 30 has an opening 301 for extracting light from the projection lens 221 and an opening 302 for connecting a connector of an external device to the connector 12. The housing 30 is made of, for example, a resin such as a polybutylene terephthalate (PBT) resin, a polypropylene (PP) resin, or an ABS resin.

The component 30a and the component 30b are fixed by snap-fit of protrusions 305 provided on both side surfaces of the component 30b into holes 304 provided in the component 30a. Further, the component 30a and the component 30c are fixed by snap-fit of protrusions 307 provided on both side surfaces of the component 30c into holes 306 provided in the component 30a. The circuit board 10 is sandwiched and fixed between the component 30a and the component 30c.

The first lens component 21 includes the condenser lens 211, a frame portion 212 having a box shape (for example, a rectangular parallelepiped) with one surface opened, and a fixing portion 215 for fixing the first lens component 21 to the second lens component 22 and the component 30b of the housing 30. The condenser lens 211 is located in a surface facing the opening surface of the frame portion 212. The first lens component 21 is made of, for example, a resin such as a polycarbonate (PC) resin or a polymethyl methacrylate (PMMA) resin.

The second lens component 22 includes the projection lens 221, a frame portion 222 having a box shape (for example, a rectangular parallelepiped) with one surface opened, and a fixing portion 225 for fixing the second lens component 22 to the first lens component 21 and the component 30b of the housing 30. The projection lens 221 is located in a surface facing the opening surface of the frame portion 222. The second lens component 22 is made of, for example, a resin such as a polycarbonate resin or a polymethyl methacrylate resin.

In the projector 1, the first lens component 21 and the second lens component 22 are fixed in a state in which the opening surface of the frame portion 212 and the opening surface of the frame portion 222 face each other, and an end surface 213, which is an edge of the opening surface of the frame portion 212, and an end surface 223, which is an edge of the opening surface of the frame portion 222, are in close contact over an entire circumference. Accordingly, a space including the pattern plate 20 at an inside surrounded by the first lens component 21 and the second lens component 22 is sealed. In order to improve the close contact, the end surface 213 and the end surface 223 are preferably polished.

When the first lens component 21 and the second lens component 22 are in close contact with each other, portions 214 protruding inward from four corners of an internal space of the frame portion 212 and portions protruding inward from the four corners of an internal space of the frame portion 222 sandwich and fix four corners of the pattern plate 20 from the front and back sides.

The first lens component 21, the second lens component 22, and the pattern plate 20 are fixed in close contact with each other by, for example, being assembled to the component 30b of the housing 30. Specifically, when the second lens component 22, the pattern plate 20, and the first lens component 21 are assembled to the component 30b, a protrusion 226 provided on the fixing portion 225 of the second lens component 22 is fitted into a hole 216 provided in the fixing portion 215 of the first lens component 71. When the fixing portion 215 is fitted into the component 30b, protrusions 217 provided on both side surfaces of the fixing portion 215 are snap-fitted into holes 303 provided the component 30b.

In the projector 1, since the first lens component 21, the second lens component 22, and the pattern plate 20 are fixed in close contact with each other, relative positioning accuracy of the condenser lens 211 provided in the first lens component 21, the projection lens 221 provided in the second lens component 22, and the pattern plate 20 is high. Therefore, it is possible to prevent the projected image from being unclear due to a relative positional deviation between the condenser lens 211, the projection lens 221, and the pattern plate 20.

Further, since spaces inside the first lens component 21 and the second lens component 22 are sealed, it is possible to prevent foreign matter such as dust from entering a periphery of the pattern plate 20. Therefore, it is possible to suppress reflection of the foreign matter on the projected image.

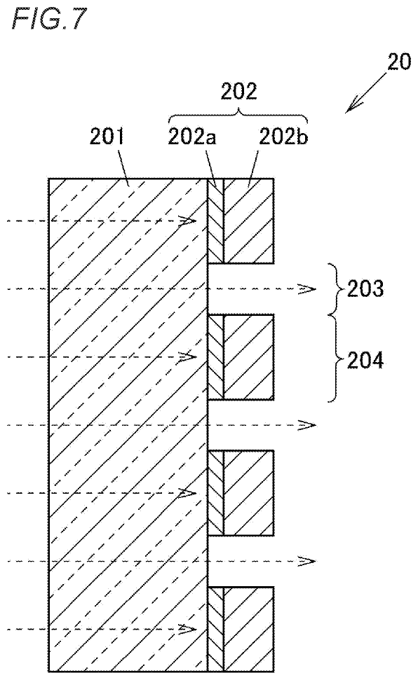

FIG. 7 is a vertical cross-sectional view of an embodiment of the pattern plate 20. The pattern plate 20 includes a transparent substrate 201 that transmits light from the light source 11 and an opaque film 202 that does not transmit light from the light source 11. The opaque film 202 has a predetermined opening pattern constituting the pattern of the pattern plate 20, and includes light transmitting portions 203 that are opening portions and light shielding portions 204 that are portions not opened.

The projected image projected by the projector 1 includes a region with a high brightness having a pattern corresponding to a pattern of the light transmitting portion 203 and a region with a low brightness having a pattern corresponding to a pattern of the light shielding portion 204.

In order to form a fine opening pattern on the opaque film 202 and to make the pattern of the pattern plate 20 fine, it is preferable to form the pattern on the opaque film 202 made of a metal formed on the transparent substrate 201 made of glass by metal etching. The opaque film 202 that is very thin (about 100 nm) can be obtained by forming a metal film by deposition, and a pattern with high accuracy can be formed by etching.

In this case, the opaque film 202 is formed of, for example, a laminated film of an opaque film 202a made of CrO and an opaque film 202b made of Cr. Further, for example, thicknesses of the opaque film 202, the opaque film 202a, and the opaque film 202b are 1.1 mm, 8 nm, and 62 nm, respectively, and a planar size of the pattern plate 20 is 8 mm×8 mm.

In a case where a pattern is formed on the opaque film 202 made of a metal formed on the transparent substrate 201 made of glass, a minimum width of the opaque film 202 on which the pattern is formed (a minimum width of the light shielding portion 204 of which the light transmitting portions 203 are formed on both sides) may be 1 μm or more and less than 10 μm, or, as an narrower example, may be 1 μm or more and 5 μL or less.

In a case where the pattern of the pattern plate 20 includes a fine portion having a resolution exceeding that of the projection lens 221, the fine portion is not resolved even the focused projected image. Specifically, in the projected image, a boundary between the region with the high brightness formed by the light transmitting portion 203 and the region with the low brightness formed by the light shielding portion 204 cannot be visually recognized, and the region with the high brightness and the region with the low brightness are mixed, and a region having a brightness between these brightnesses (the brightness lower than the brightness of the region where a resolved brightness is high and higher than the brightness of the region where a resolved brightness is low) is visually recognized.

Thus, it is possible to express the brightness between the brightness of the portion formed by the light transmitting portion 203 and the brightness of the portion formed by the light shielding portion 204 in the projected image using a fine portion not resolved in the projected image focused on the pattern of the pattern plate 20.

The configuration of the pattern plate 20 is not limited to that shown in FIG. 7. For example, a plate that is made of a transparent resin transmitting light from the light source 11, and includes, on one surface thereof, a light transmitting portion composed of a flat surface and a light shielding portion composed of an inclined surface inclined with respect to the flat surface may be used as the pattern plate 20. In the light shielding portion of the pattern plate 20, light is shielded by utilizing total reflection of light on the inclined surface.

(Effects of Embodiment)

In the vehicle interior image projection system 100 according to the embodiment of the present invention described above, since the projector 1 enlarges and projects the pattern of the pattern plate 20 using the projection lens 221, and the projector 1 installed such that the optical axis L is inclined with respect to the surface of the projection target 2, the path difference between the portion in the projection region R close to the projector 1 and the portion far from the projector 1 increases, and a range of expression related to luminance in the projected image is widened. Accordingly, not only the pattern of the pattern plate 20 is simply projected, but a variety of expressions in the projected image can be realized.

Although the embodiment of the present invention has been specifically described, the present disclosure is not limited to the above embodiment and various modifications can be made without departing from the gist of the invention. Constituent elements in the embodiment can be freely combined without departing from the gist of the invention.

The above embodiment is not intended to limit the scope of the appended claims. Further, it should be noted that all combinations of the features described the embodiment are not necessarily essential to the solution of the invention.

### REFERENCE SIGNS LIST

1 projector

2 projection target

50 door

51 instrument panel

52 console

100 vehicle interior image projection system

221 projection lens

What is claimed is:

1. A vehicle interior image projection system comprising:
a projector configured to project an image onto a projection target,
wherein the projector is provided so that an optical axis of the projector is inclined with respect to a surface of the projection target, and
a projection region of the image projected onto the projection target by the projector has an elliptical shape.

2. The vehicle interior image projection system according to claim 1,
wherein an angle formed by the optical axis of the projector and the surface of the projection target is 5° or more and 80° or less.

3. The vehicle interior image projection system according to claim 1,
wherein an image enlargement ratio of the projector at a projection distance of 400 mm is 50 times or more and 100 times or less.

4. The vehicle interior image projection system according to claim 1,
wherein the projector is provided inside a door, and
the projection target is a door trim attached to the door.

5. The vehicle interior image projection system according to claim 2,
wherein the projector is provided inside a door, and
the projection target is a door trim attached to the door.

6. The vehicle, interior image projection system according to claim 3,
wherein the projector is provided inside a door, and
the projection target is a door trim attached to the door.

7. The vehicle interior image projection system according to claim 1,
wherein the projector is provided in an instrument panel or a console, and
the projection target is a floor of a vehicle.

8. The vehicle, interior image projection system according to claim 2,
wherein the projector is provided is as instrument panel or a console, and
the projection target is a floor of a vehicle.

9. The vehicle interior image projection system according to claim 3,
wherein the projector is provided in an instrument panel or a console, and
the projection target is a floor of a vehicle.
